(19) United States
(12) Patent Application Publication
(10) Pub. No.: US 2024/0022851 A1
(43) Pub. Date: Jan. 18, 2024

(54) Block Formed of Porous Material and Microspeaker Enclosure Including the Same

(71) Applicant: EM-TECH Co., Ltd., Gyeongsangnam-do (KR)

(72) Inventors: Yong Hee Oh, Gyeongsangnam-do (KR); Young Uk Jo, Gyeongsangnam-do (KR); Dong Hyun Yun, Gyeongsangnam-do (KR)

(21) Appl. No.: 18/219,893

(22) Filed: Jul. 10, 2023

(30) Foreign Application Priority Data
Jul. 12, 2022 (KR) 1020220085446

(51) Int. Cl. H04R 1/28; H04R 1/02

(52) U.S. Cl. CPC H04R 1/288; H04R 1/02; H04R 2201/003

(57) ABSTRACT

Provided is a block formed of a porous material. In the block formed of a porous material, which is mounted together with a microspeaker in an enclosure case to adsorb air to serve as a virtual back volume, the block is manufactured by blocking porous particles including silicon and aluminum, and in a pore diameter of the porous block, dV/dlog(D) pore volume at 20 nm is 0.1 cm³/g or more.

### TECHNICAL FIELD

The present disclosure relates to a block formed of a porous material.

### BACKGROUND

A microspeaker is a device provided in portable devices or the like to generate sound and is installed in various devices according to the recent development of mobile devices. In particular, recently developed mobile devices tend to be lighter, smaller, and slimmer to facilitate portability, and accordingly, microspeakers installed in mobile devices are required to be smaller and slimmer.

However, when microspeakers are miniaturized or slimmed, the area of a diaphragm becomes smaller and the size of a resonance space, in which sound generated as a diaphragm vibrates resonates and is amplified, also decreases, so sound pressure decreases. This decrease in sound pressure is particularly noticeable in a low-frequency range, and in order to strengthen sound pressure in the low-frequency range, technology for placing an air adsorbent, a porous material, in the resonance space so that the porous material adsorbs air molecules to create a virtual acoustic space, thereby enhancing a sound pressure level (SPL) of the low-frequency range and reducing total harmonic distortion (THD) of the low-frequency range, has been developed.

FIG. 1 is a view illustrating a microspeaker enclosure filled with a porous material according to the related art. According to the related art, a microspeaker 1 is mounted on enclosure cases 2 and 3, and a back volume 4 is provided between the upper and lower enclosure cases 2 and 3. The back volume 4 communicates with a back hole of the microspeaker 1 and is filled with porous particles 5. As the porous particles 5 adsorb air molecules, a virtual acoustic space is formed to provide an effect as if the back volume 4 is expanded.

However, the microspeaker enclosure filled with a porous material according to the related art is disadvantageous in that noise occurs when the microspeaker 1 generates sound or the porous particles 5 vibrate due to an impact applied to the enclosure.

In order to solve these disadvantages, technologies for blocking porous particles and installing the blocked porous particles in an enclosure have been disclosed. However, in the case of blocking porous particles, air may not be circulated to particles located inside the porous particle block, and thus, as the size of the block increases, air adsorption performance gradually decreases.

### SUMMARY

An aspect of the present disclosure provides a microspeaker enclosure including a porous block formed of porous particles to increase air circulation capability.

According to an aspect of the present disclosure for achieving the above objects, there is provided a block formed of a porous material, which is mounted together with a microspeaker in an enclosure case to adsorb air to serve as a virtual back volume, wherein the block is manufactured by blocking porous particles including silicon and aluminum, and in a pore diameter of the porous block, dV/dlog(D) pore volume at 20 nm is 0.1 cm³/g or more.

Also, in an aspect of an embodiment, the porous particles forming the porous block may include any one or more of zeolite, activated carbon, a metal-organic framework (MOF), an aerogel, and porous silica.

Also, in an aspect of an embodiment, at least one surface of the porous block may be formed with one or more air passages that increase a contact area with air and help circulation of air.

Also, in an aspect of an embodiment, a width and length of the porous block may be 1.5 times or more of a thickness of the porous block.

According to an aspect of the present disclosure, a microspeaker enclosure includes: a micro speaker; an enclosure case, in which a microspeaker is mounted, including a back volume communicating with the micro speaker; and a block installed in the back volume and formed of a porous material adsorbing air to serve as a virtual back volume, wherein, in a pore diameter of the porous block, dV/dlog(D) pore volume at 20 nm is 0.1 cm³/g or more.

Also, in an aspect of an embodiment, the porous block may have a film attached to one surface thereof.

Also, in an aspect of an embodiment, the porous block may be installed by attaching the surface, to which the film is attached, to the enclosure case.

The microspeaker enclosure including a block formed by mixing porous particles having a relatively large pore size with porous particles having high air adsorption capability may have improved air circulation capability.

### BRIEF DESCRIPTION OF THE DRAWINGS

FIG. 1 illustrates the microspeaker enclosure filled with a porous material according to the related art;

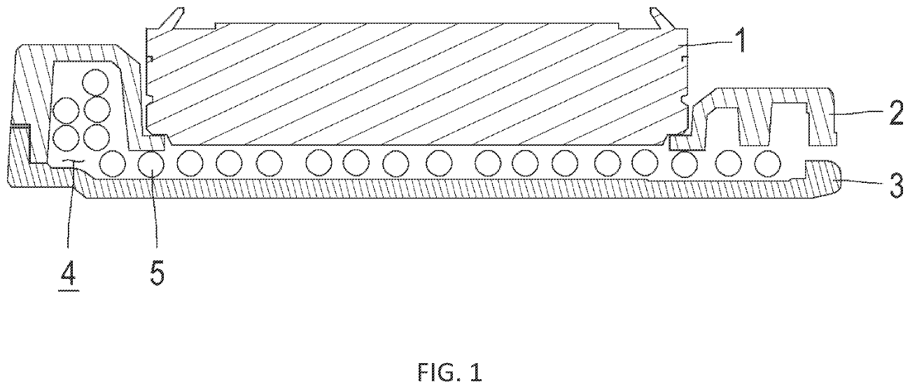

FIG. 2 is an exploded view of a microspeaker enclosure including a block formed of a porous material according to a first embodiment of the present disclosure;

FIG. 3 is a cross-sectional view of a microspeaker enclosure including a block formed of a porous material according to the first embodiment of the present disclosure;

FIG. 4 shows a graph of dV/dlog (D) pore volume according to a pore diameter of porous particles according to the related art;

FIG. 5 shows a graph of dV/dlog (D) pore volume according to a pore diameter of porous particles according to an embodiment;

FIG. 6 is a cross-sectional view of a block formed of a porous material according to a second embodiment of the present disclosure;

FIG. 7 is a cross-sectional view of a block formed of a porous material according to a third embodiment of the present disclosure; and

FIG. 8 is a schematic diagram of a microspeaker enclosure including a block formed of a porous material according to a fourth embodiment of the present disclosure.

### DETAILED DESCRIPTION

Hereinafter, embodiments are described in detail with reference to the accompanying drawings.

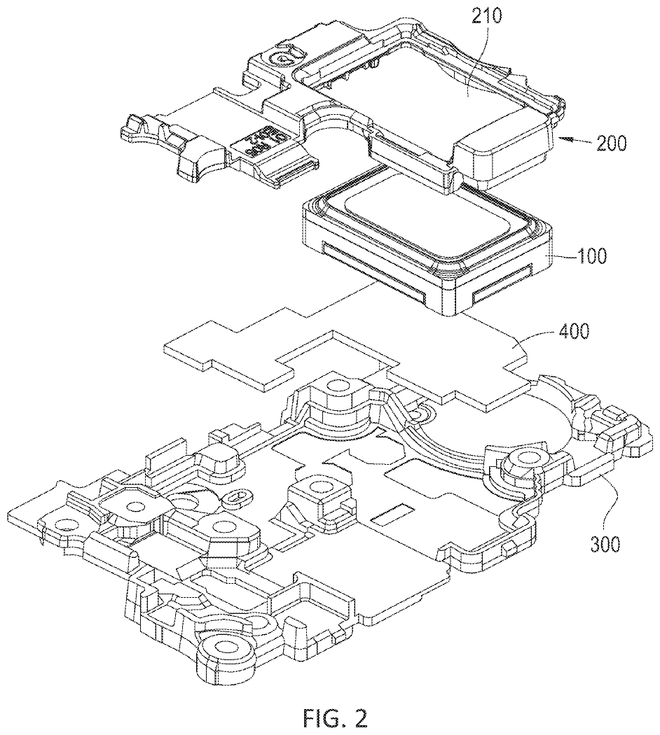

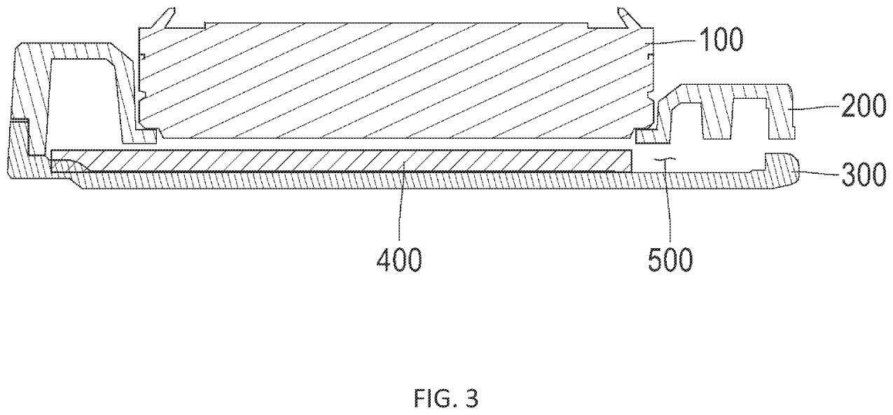

FIG. 2 is an exploded view of a microspeaker enclosure including a block formed of a porous material according to a first embodiment of the present disclosure, and FIG. 3 is a cross-sectional view of a microspeaker enclosure including a block formed of a porous material according to the first embodiment of the present disclosure.

The microspeaker enclosure including a block formed of a porous material according to the first embodiment of the present disclosure includes a microspeaker 100, enclosure cases 200 and 300, and a porous block 400. The enclosure cases 200 and 300 may include an upper enclosure case 200 and a lower enclosure case 300 combined to form a back volume 500 therein. The upper enclosure case 200 includes a microspeaker accommodating portion 210 so that the microspeaker 100 may be mounted therein. A backhole (not shown) of the microspeaker 100 communicates with the back volume 500 through the microspeaker accommodating portion 210.

The porous block 400 may be formed by blocking porous particles and then installed in the back volume 500. The porous block 400 is manufactured by mixing porous particles having excellent adsorption capability of nitrogen and oxygen occupying most of air and then blocking the porous particles.

Here, the porous block 400 are preferably mixed at a mass ratio of silicon to aluminum in a range of 150:1 to 400:1. The porous particles are excellent in adsorbing not only air but also moisture in the air. Therefore, when moisture is adsorbed on the porous particles, the air adsorption performance may be lowered. Here, when the porous particles are mixed at the mass ratio of silicon to aluminum by 150:1 to 400:1, hydrophobicity of the porous block 400 may be improved, and accordingly, the air adsorption performance may be improved.

Meanwhile, types of porous particles forming the porous block 400 may include any one or more of zeolite, activated carbon, an MOF, an aerogel, and porous silica. The porous particles 500 used to improve acoustic properties by functioning as a virtual back volume are mainly formed of zeolite, and have air adsorption properties that improve acoustic performance up to 300 μm to 500 μm in diameter of zeolite grains. However, even if manufactured in the same component ratio, if the diameter of the zeolite grains is more than 500 μm, the air adsorption properties that improve acoustic performance start to deteriorate. The reason why the properties of improving acoustic performance decrease depending on the size of particles is because air circulation should be made to the inside of most of the filled porous particles according to an operating speed of the microspeaker, but the diameter of the zeolite grains exceeding 500 μm may make air circulation difficult and the air adsorption performance of the porous particles gradually decreases. For example, when a block of 1 cm³ is formed of zeolite, the blocked zeolite has no ability to improve acoustic properties.

Therefore, in order to assist air circulation to the zeolite particles, a material having a high air circulation capability should be mixed. In the present disclosure, as a material having high air circulation capability, porous particles having a porosity of 50% or more are mixed during the manufacture of the porous block 400. As porous particles having high air circulation capability, aerogel, porous silica, and MOFs may be used alone or in combination.

Meanwhile, a pore size of the porous block 400 is preferably a dV/dlog (D) pore volume of 0.1 cm³/g or more at a diameter of 20 nm. The porous block 400 has an excellent effect when the dV/dlog (D) pore volume at a pore diameter of 20 nm is above a certain level.

In addition, a material having adhesiveness, that is, a binder, may be added to the porous block 400 to form a block by combining porous particles with each other. The shape of the porous block 400 is not limited, and may have various shapes, such as a polyhedron or a shape corresponding to the back volume 500.

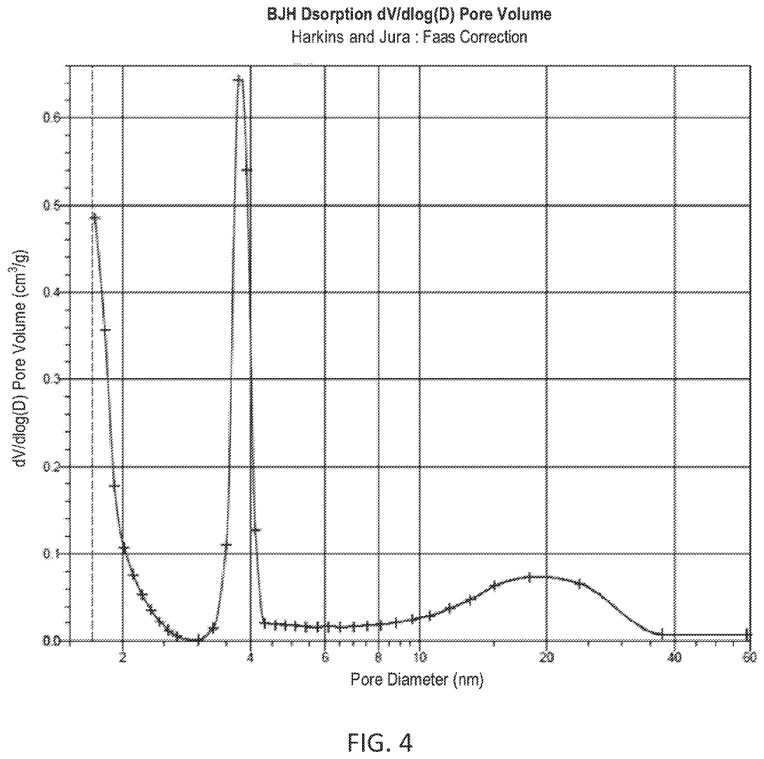

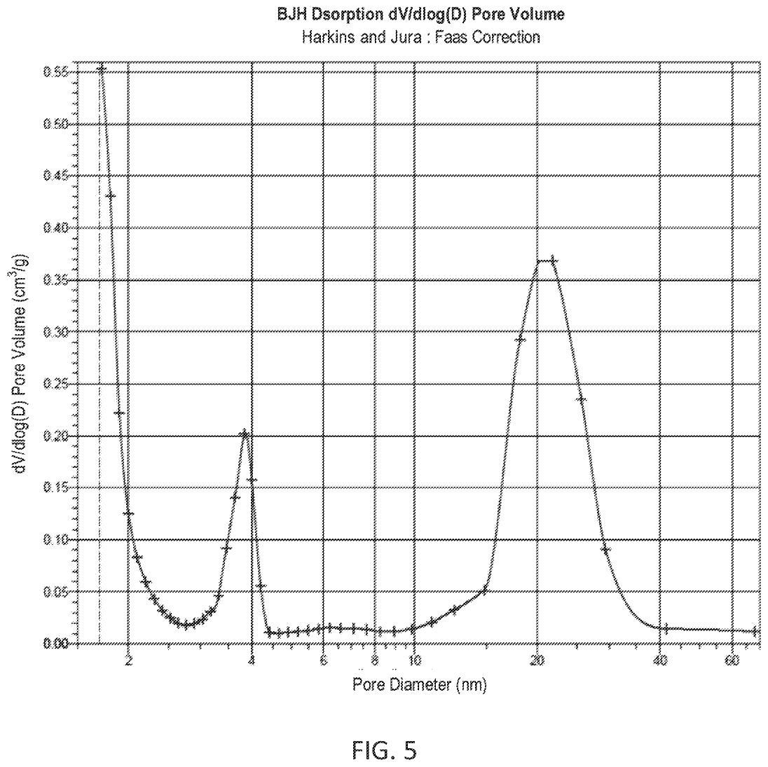

FIG. 4 shows a graph of dV/dlog (D) pore volume according to a pore diameter of porous particles according to the related art, and FIG. 5 shows a graph of dV/dlog (D) pore volume according to a pore diameter of porous particles according to an embodiment.

Referring to FIGS. 4 and 5, when comparing the dV/dlog (D) pore volume of the porous particles with the dV/dlog (D) pore volume of the porous block according to the present disclosure, it can be seen that dV/dlog(D) pore volume of the porous particle according to the related art is less than 0.1 at 20 nm, whereas dV/dlog(D) pore volume of the porous block according to the present disclosure increases significantly at 20 nm.

This may be construed that, since the porous block 400 is formed by mixing zeolite particles with good air adsorption performance with an aerogel, porous silica, MOF particles, etc., having a larger pore size and porosity than zeolite to have better air circulation performance than air adsorption performance, dV/dlog(D) pore volume increases at 20 nm.

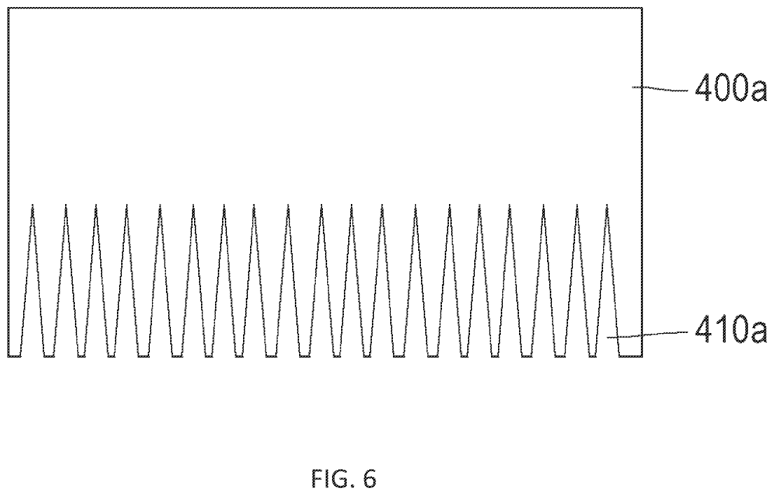

FIG. 6 is a cross-sectional view showing a block 400a formed of a porous material according to a second embodiment of the present disclosure.

The block 400a formed of a porous material according to the second embodiment of the present disclosure is manufactured by blocking porous particles as in the first embodiment, to form an air passage 410a which enlarges a contact area with air and helps air circulation. The air passage 410a is a recess formed on at least one surface of the porous block 400a, and is preferably formed as a comb-shaped recess as shown in FIG. 4, but a specific shape of the recess is not limited thereto.

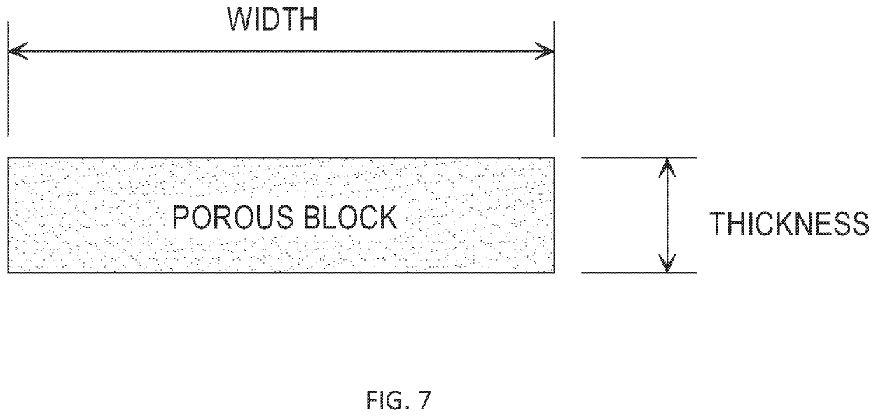

FIG. 7 is a cross-sectional view illustrating a block formed of a porous material according to a third embodiment of the present disclosure.

The block formed of a porous material according to the third embodiment of the present disclosure is characterized in that the thickness is limited to improve air adsorption performance and improve air circulation. The porous block preferably has dimensions of 1.5 or more times the width and length compared to the thickness.

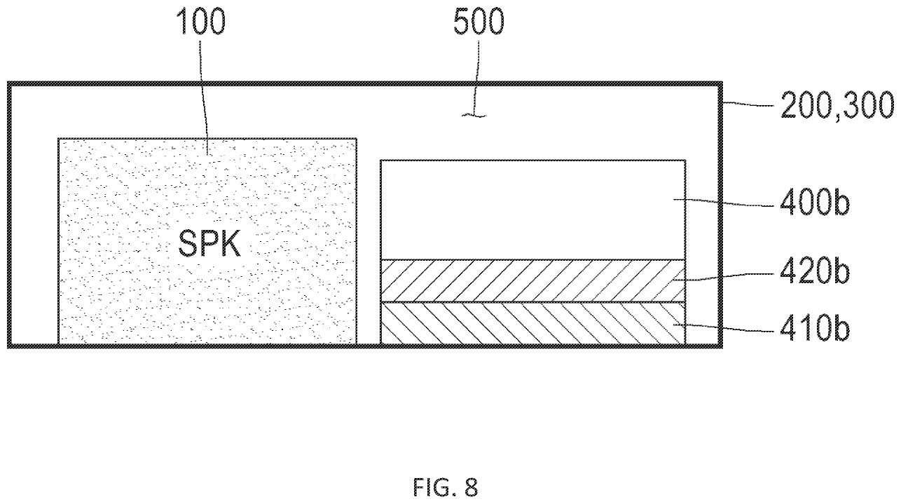

FIG. 8 is a schematic diagram of a microspeaker enclosure including a block formed of a porous material according to a fourth embodiment of the present disclosure.

A film 410b is attached to one surface of a block 400b formed of a porous material according to the fourth embodiment of the present disclosure. This is to enhance adhesiveness, strength, or durability of the porous block 400b, and the film 410b is attached to the porous block 400b using an adhesive member 420b, such as a bond or a tape.

The porous block 400b to which the film 410b is attached is installed in a back volume 500 as in the first embodiment, and it is preferable that the surface to which the film 410b is attached is attached to the enclosure cases 200 and 300. When the film 410b is attached, the air adsorption performance may deteriorate due to poor air circulation on the film attachment surface, and thus, an installation surface for fixing the film attachment surface to the enclosure cases 200 and 300 may be utilized to minimize the surface in which the air adsorption performance may deteriorate in the porous block.

As used herein, the terms “having,” “containing,” “including,” “comprising,” and the like are open-ended terms that indicate the presence of stated elements or features, but do not preclude additional elements or features. The articles “a,” “an” and “the” are intended to include the plural as well as the singular, unless the context clearly indicates otherwise.

It is to be understood that the features of the various embodiments described herein may be combined with each other, unless specifically noted otherwise.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A block configured to be mounted together with a microspeaker in an enclosure case to adsorb air to serve as a virtual back volume, the block comprising:
a porous material manufactured by blocking porous particles including silicon and aluminum,
wherein in a pore diameter of the block, dV/dlog(D) pore volume at 20 nm is 0.1 cm³/g or more.

2. The block of claim 1, wherein the porous particles include one or more of zeolite, activated carbon, a metal-organic framework (MOF), an aerogel, and porous silica.

3. The block of claim 1, wherein at least one surface of the block has one or more air passages that increase a contact area with air and help circulation of air.

4. The block of claim 1, wherein a width and a length of the block are 1.5 times or more of a thickness of the block.

5. A microspeaker enclosure, comprising:
a micro speaker;
an enclosure case, in which a microspeaker is mounted, including a back volume communicating with the micro speaker; and
a block installed in the back volume and formed of a porous material adsorbing air to serve as a virtual back volume,
wherein in a pore diameter of the block formed of the porous material, dV/dlog(D) pore volume at 20 nm is 0.1 cm³/g or more.

6. The microspeaker enclosure of claim 5, wherein a film is attached to one surface of the block formed of the porous material.

7. The microspeaker enclosure of claim 6, wherein the block formed of the porous material is installed by attaching the surface, to which the film is attached, to the enclosure case.

8. A method of manufacturing a block formed of a porous material and configured to be mounted together with a microspeaker in an enclosure case to adsorb air to serve as a virtual back volume, the method comprising:
blocking porous particles including silicon and aluminum,
wherein in a pore diameter of the block, dV/dlog(D) pore volume at 20 nm is 0.1 cm³/g or more.

9. The method of claim 8, wherein the porous particles include one or more of zeolite, activated carbon, a metal-organic framework (MOF), an aerogel, and porous silica.

10. The method of claim 8, further comprising:
forming at least one surface of the block with one or more air passages that increase a contact area with air and help circulation of air.

11. The method of claim 8, wherein a width and a length of the block are 1.5 times or more of a thickness of the block.

12. The method of claim 8, further comprising:
attaching a film to one surface of the block.

13. The method of claim 8, wherein blocking the porous particles including silicon and aluminum comprises:
mixing the porous particles including silicon and aluminum; and
then blocking the porous particles including silicon and aluminum.

14. The method of claim 13, wherein the porous particles are mixed at a mass ratio of silicon to aluminum in a range of 150:1 to 400:1.
